(19) United States
(12) Patent Application Publication
(10) Pub. No.: US 2009/0026661 A1
(43) Pub. Date: Jan. 29, 2009

(54) Method and Apparatus for Shaping of Fabrics

(76) Inventor: Richard Sturman, Nottingham (GB)

Correspondence Address: DICKSTEIN SHAPIRO LLP, 1825 EYE STREET NW, Washington, DC, 20006-5403, US

(21) Appl. No.: 11/794,060

(22) PCT Filed: Dec. 23, 2005
(86) PCT No.: PCT/GB2005/005087

§ 371 Date: Mar. 17, 2008

(30) Foreign Application Priority Data
Dec. 24, 2004 (GB) 0428332.1

(51) Int. Cl. B06B 1/02; B29C 59/10; B29C 59/02; B29C 59/04; B29C 59/16

(52) U.S. Cl. 264/400; 264/443; 425/174.2

(57) ABSTRACT

In the field of shaping fabrics there is a need for a method and apparatus for the shaping of fabrics which utilises ultrasonic techniques while improving the versatility of being able to change the profile to be cut/embossed. A method of shaping fabric comprises creating a former having a surface relief which defines the desired profile and/or surface pattern, placing the fabric to be shaped onto the former to overlie said surface relief and remain in a fixed position relative thereto, and sweeping an ultrasonic head in at least two dimensions over the area of fabric overlying the former whilst pressing the fabric between said head and the former such that the profile and/or surface pattern on said former is transferred to said fabric.

The present invention relates to a method and apparatus for shaping of fabrics.

In the context of the present invention, ‘shaping’ encompasses cutting or severing a fabric to define a desired profile and/or creating a relief pattern on the surface of a fabric.

It is known that laser cutting machines are capable of accurately cutting profiles having intricate shapes in a sheet material. Laser cutting machines usually include a laser head mounted on a support carriage which is movable under the control of a computer in x/y axes over a support bed. Accordingly with such a machine it is a relatively simple matter to change the machine to cut different profiles; this is done by reprogramming the computer and does not require modification of the cutting apparatus, i.e. the laser or support bed.

Unfortunately laser cutting machines have limited use in the cutting of fabric for the making up of garments since when using lasers to cut a fabric there is a tendency for the fabric to scorch near to the cut edges; this is particularly unsightly when cutting light coloured fabrics.

Ultrasonic cutting machines are known which operate to cut fabric to a predefined profile or emboss a predetermined pattern onto the surface of fabric. With such a machine, the profile to be cut or to be embossed onto the fabric is usually carried on an ultrasonic head beneath which the fabric is passed. In order to cut or emboss the fabric, the head has to vibrate ultrasonically and to achieve this the head is connected to a resonator. A given resonator can work effectively with a given range of head sizes but if it is desired to use a head outside this range of sizes, then a different resonator is required. A benefit of using the ultrasonic technique for cutting and/or embossing a surface pattern onto a fabric is that scorching associated with laser cutting is avoided.

However, the need to match specific heads with specific resonators restricts the versatility of this type of machine for creating a wide range of profiles and/or surface patterns since to alter the machine to cut or emboss a different profile/pattern entails manufacture of a new head having the desired profile/pattern and restricts the size of the head to that which can be mounted on the resonator (otherwise a differently sized resonator will also be required). Changing of profiles/patterns is therefore costly and time consuming with this type of ultrasonic machine.

A general aim of the present invention is to provide a method and apparatus for the shaping of fabrics utilising ultrasonic techniques whilst improving the versatility of being able to change the profile to be cut/embossed.

According to one aspect of the present invention there is provided a method of shaping fabric comprising creating a former having a surface relief which defines the desired profile and/or surface pattern, placing the fabric to be shaped onto the former to overlie said surface relief and remain in a fixed position relative thereto, and sweeping an ultrasonic head in at least two dimensions over the area of fabric overlying the former whilst pressing the fabric between said head and the former such that the profile and/or surface pattern on said former is transferred to said fabric.

According to another aspect of the present invention there is provided apparatus for the shaping of fabric, the apparatus including a support bed upon which a former may be mounted, the former having a surface relief which defines the desired profile and/or surface pattern, an ultrasonic head mounted above the support bed by a desired spacing, the support bed and ultrasonic head being relatively movable to enable the ultrasonic head to sweep over said surface relief on a former mounted on the support surface, the ultrasonic head and support bed also being relatively movable to adjust said desired spacing.

Various aspects of the present invention are hereinafter described with reference to the accompanying drawings, in which:

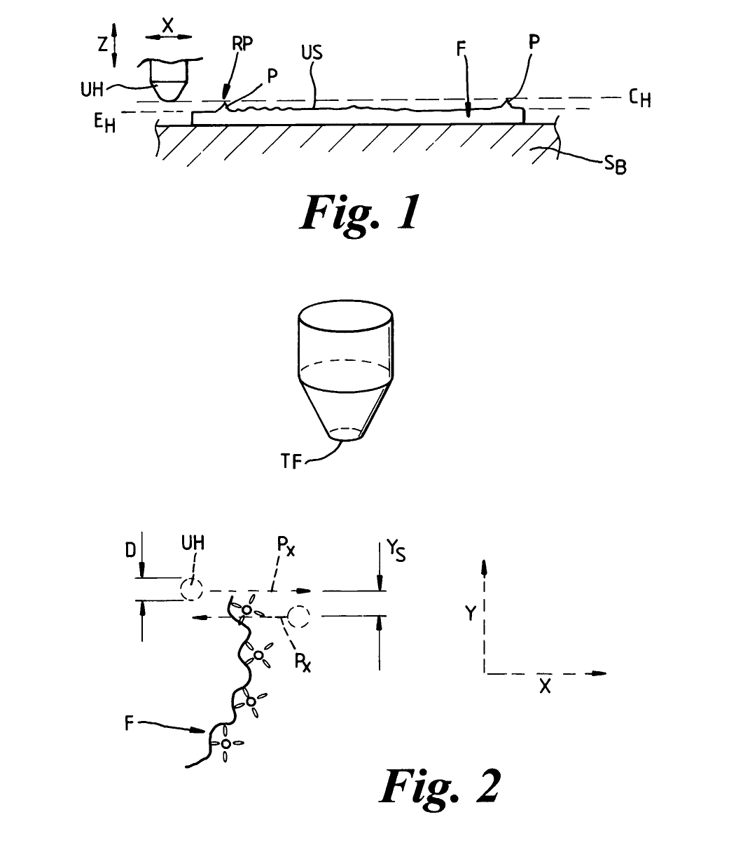

FIG. 1 is a diagrammatic side view depicting the principle of operation of a shaping apparatus according to the present invention;

FIG. 2 is a schematic perspective view of an ultrasonic head for use in an apparatus according to the present invention;

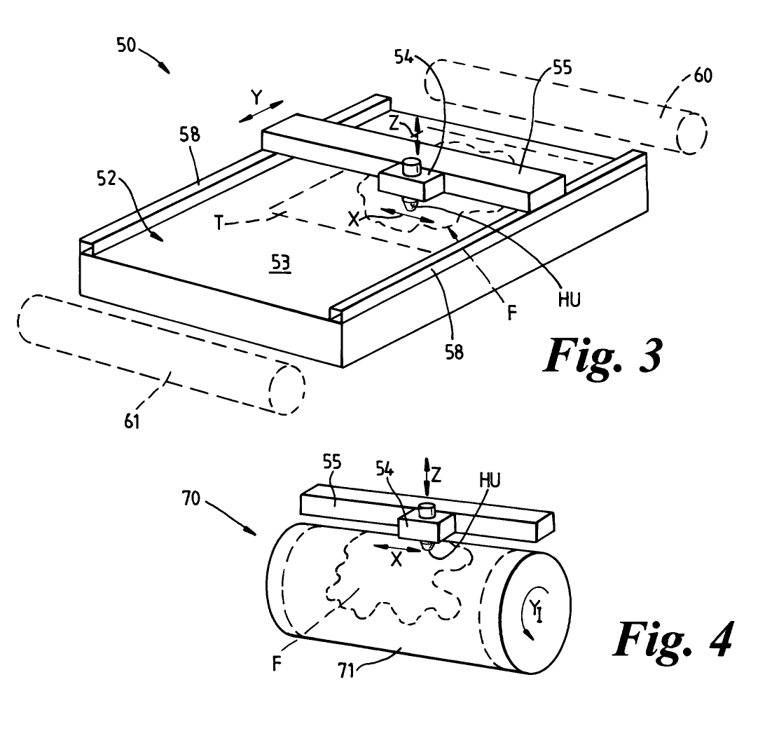

FIG. 3 is a schematic perspective view of an apparatus according to a first embodiment of the present invention:

FIG. 4 is a schematic perspective view of an apparatus according to a second embodiment of the present invention.

Referring initially to FIG. 1 there is shown a former F seated upon a support bed S_{B}. The former F has an upper surface US upon which there is formed a relief pattern RP. The relief pattern is three-dimensional in that it is defined by a series of projections or ridges P having a height in a Z-axis direction. the pattern extending in an X-axis direction (across the page in FIG. 1) and in a Y-axis direction (perpendicular to the page in FIG. 1).

An ultrasonic head UH is located above the support bed S_{B} and is spaced above the bed S_{B} by a desired height spacing to achieve cutting and/or embossing of fabric located between the head UH and former F. The height spacing between the head UH and support bed S_{B} is adjustable in the Z axis direction by moving the head UH and/or the support bed S_{B} in the Z axis direction.

To achieve cutting and/or embossing of a fabric, the head UH and/or bed S_{B} are moved relative to one another in the X and Y axes directions such that the head UH passes over the relief pattern RP in both the X and Y axes directions. The head UH is chosen to have a smooth terminal face TF which acts to press fabric located between itself and the former into contact with the ridges/projections of the relief pattern RP.

As the head UH vibrates ultrasonically, the highest ridges/projections will penetrate the fabric to the greatest extent and the lowest ridges/projections will penetrate the fabric to the least extent. The relief pattern defined on the surface of the former is thereby transferred onto the surface of the fabric.

If the height spacing is adjusted such that the highest ridges/projections penetrate fully through the fabric, then the fabric will be cut to a profile defined by these ridges/projections.

The former F serves to define the relief pattern which is to be transferred onto the fabric. Accordingly the former F may be any suitable material of sheet-like form which has sufficient inherent resistance to deformation when pressed by the ultrasonic head UH. Typically for example, the former F may be made from a fibre board, sheet metal or a rigid plastics material. The relief pattern RP may be formed on the surface of the former by any suitable technique such as laser cutting/etching, spark erosion etc.

As described above, the former F is mounted on a support bed S_{B}. A purpose of the support bed S_{B} is to provide a rigid anvil type support to the former F such that the former F is maintained rigid when the ultrasonic head UH passes across it; i.e. the pressing action of the ultrasonic head UH is fully resisted without deflection of the former F.

This ensures that the height adjustment of the ultrasonic head UH relative to the former F remains consistent throughout the range of movement of the head UH in the X and Y axes directions and so ensures that the relief pattern RP on the former F is accurately transferred to the fabric.

The use of a support bed SB thereby enables a relatively thin, flexible former F, to be used. Accordingly a relatively large former F (in the X and Y axes directions) of lightweight may be produced for ease of handling and low cost.

It is however envisaged that the former F may be produced so as to be sufficiently rigid to resist deflection by itself and so be able to act as an anvil without the need for a separate rigid support bed S_{B}. In such a situation, the former F and support bed S_{B} may be considered to be integrally connected.

Apparatus according to a first embodiment 50 of the invention is schematically illustrated in FIG. 3. Parts similar to those described with reference to FIG. 1 are designated by the same references.

In the embodiment 50, the support bed S_{B} is defined by a solid, static table top 52. The table top 52 has a flat, planar upper surface 53.

The ultrasonic head HU is mounted in a carriage 54 which is movably mounted on a cross-rail 55. The carriage 54 is moved along the cross-rail 55 by a first controllable motor (not shown) so as to move the head HU in the X-axis direction.

The cross-rail 55 is movably mounted at opposite ends for movement along opposed rails 58 secured to the table top 52. The rails 58 extend perpendicularly to the cross-rail 55 and so movement of the cross-rail 55 along rails 58 causes the ultrasonic head HU to be moved in the Y-axis direction. Cross-rail 55 is molted along rails 58 by a second controllable motor (not shown).

The ultrasonic head KU is preferably mounted in carriage 54 such that its height above the table top 52 may be adjusted in the Z-axis direction. Adjustment in this way helps to eliminate fabric distortion as the ultrasonic head UH passes across the former F. Such adjustment can also be used to give clear pattern definition in areas where patterning is desired.

Preferably movement of the ultrasonic head HU relative to carriage 54 is caused by a third controllable motor (not shown).

In use, a former F (shown in broken lines) is laid upon the table top 52 and secured in position by, for example, suitable adhesive or a vacuum applied under the table top 52. Fabric T to be cut/embossed is then laid over the former F and held in position whilst the cutting/embossing operation is performed. Advantageously, instead of laying a single piece of fabric T over the former, a web of fabric is preferably intermittently fed across the table top 52. Conveniently this may be achieved by providing a fabric feed roller 60 and fabric take-up roller 61 at opposite ends of the table top 52, the fabric to be cut/embossed extending between the rollers 60, 61 under tension. During the cutting/embossing operation, rollers 60, 61 would be held stationary and then after the cutting/embossing operation, would be indexed to advance fresh fabric for the next cutting/embossing operation.

As illustrated schematically in FIG. 5, during the cutting/embossing operation, the head HU sweeps over the entire area of the pattern on the former F in order to transfer the desired cut profile and/or surface embossing onto the fabric. Sweeping of the head HU is preferably achieved by moving the head HU along a series of paths P_{X} spaced in the Y-axis direction. This is achieved by moving the cross-rail 55 intermittently, along rails 58 through a series of stationary positions; the position of each stationary position defining the Y co-ordinate for a path P_{X} and the spacing between the stationary positions defining the spacing between adjacent paths P_{X}. Whilst the cross-rail 55 is held at a stationary position, the carriage 54 is moved along cross-rail 55 to thereby move the head HU along a path P_{X} in the X-axis direction.

For a head HU having a terminal pressing face having a dimension of say D in the Y-axis direction, the spacing Y_{S} between paths P_{X} is preferably chosen to be less than D so that successive sweeps of the head HU along adjacent paths P_{X} overlap to thereby ensure continuity of transfer of the pattern on the former to the fabric.

To cut/emboss fabric on the apparatus 50, a setting-up process is preferably performed initially. The setting-up process entails adjusting the height of the head HU to achieve the desired spacing above the former F; this is done by moving the head to a reference location on the former F and lowering the head by operation of the third motor to press a sample piece of fabric against the former. The head HU is operated ultrasonically and the effect on the sample fabric is inspected. Depending upon the results, the height of the head is changed and the process repeated until the desired results are achieved. This setting-up process enables the apparatus to be tailored to a particular batch of fabric (which may differ in thickness to a separate batch of the same fabric).

In the embodiment illustrated in FIG. 3, the former F is static during the cutting/embossing operation and the head HU is moved in both the X and Y axes in order to sweep over the pattern carried by the former F.

An alternative apparatus 70 is shown schematically in FIG. 4 to illustrate an example where the head HU is arranged to move in the X-axes direction only and the former F is arranged to move in the Y-axis.

Conveniently, in apparatus 70 the former F is a flexible plate mounted on the periphery of a roller 71. The carriage 54 is mounted on a cross-rail 55 in a similar manner to that in apparatus 50 but the cross-rail 55 is mounted so as to be stationary. As in apparatus 50, the head HU is mounted in carriage 54 so as to be movable in the Z-axis direction.

In use, the roller 71 is indexed through a series of rotary positions in the direction of arrow Y₁ by an intermittent drive means (not shown). At each rotary position, the roller 71 is held stationary whilst the head HU is moved in the X-axis direction to sweep over the former F. Once a sweep has been completed, the roller 71 is indexed to the next rotary position. The spacing between adjacent rotary positions is chosen to ensure continuity of transfer of the pattern on the former in a similar manner to that described in relation to apparatus 50.

1. A method of shaping fabric comprising creating a former having a surface relief which defines the desired profile and/or surface pattern, placing the fabric to be shaped onto the former to overlie said surface relief and remain in a fixed position relative thereto, and sweeping an ultrasonic head in at least two dimensions over the area of fabric overlying the former whilst pressing the fabric between said head and the former such that the profile and/or surface pattern on said former is transferred to said fabric.

2. A method according to claim 1 wherein the former is held static and the head is moved in X and Y directions over the former, said directions X and Y being laterally inclined to one another.

3. A method according to claim 1 wherein the former and fabric overlaying the fabric are moved together in unison through a succession of positions spaced in a Y direction, the former and fabric being held temporarily stationary at each successive position whilst the head is moved over the fabric in an X direction which is laterally inclined relative to the Y direction.

4. A method according to claim 2 wherein the head is further moved in a Z direction, said Z direction being perpendicular relative to both the X and Y directions.

5. A method according to claim 1 wherein the pattern formed in the former is formed, at least in part, by a laser cutting process.

6. A method according to claim 1 wherein the pattern formed on the former is formed, at least in part, by an etching or spark erosion process.

7. A method according to claim 1 wherein the pattern is formed on a sheet material in order to define said former, the former then being attached to a rigid bed to prevent deflection of the former when the head is swept thereover.

8. (canceled)

9. An apparatus for the shaping of fabric, the apparatus including a support bed upon which a former may be mounted, the former having a surface relief which defines the desired profile and/or surface pattern, an ultrasonic head mounted above the support bed by a desired spacing, the support bed and ultrasonic head being relatively movable to enable the ultrasonic head to sweep over said surface relief on a former mounted on the support surface, the ultrasonic head and support bed also being relatively movable to adjust said desired spacing.

10. An apparatus according to claim 9 wherein the support surface is static and the head is mounted on a carriage movable along a cross-rail in a given, X, direction, the cross-rail being movable along the support surface in a given, Y, direction which is laterally inclined relative to said X direction.

11. An apparatus according to claim 9 wherein the support surface is movable in a given, Y, direction through a succession of predetermined positions at which the support surface is temporarily statically held, the head being mounted on a carriage which is movable along a static cross-rail in a given, X, direction, said X and Y directions being laterally inclined relative to one another.

12. An apparatus according to claim 11 wherein said support surface is in the form of a roller.

13. An apparatus according to claim 10 wherein the head is movably mounted in the carriage so that the height of the head above said support surface can be adjusted.

14. An apparatus according to claim 9 wherein the former is formed from a sheet material.

15. (canceled)

16. A method according to claim 3 wherein the head is further moved in a Z direction, said Z direction being perpendicular relative to both the X and Y directions.

17. An apparatus according to claim 11 wherein the head is movably mounted in the carriage so that the height of the head above said support surface can be adjusted.
